(19) United States
(12) Patent Application Publication
(10) Pub. No.: US 2025/0353482 A1
(43) Pub. Date: Nov. 20, 2025

(54) BRAKE ACTUATOR AND METHOD FOR OPERATING A BRAKE ACTUATOR

(71) Applicant: ZF Active Safety GmbH, Koblenz (DE)

(72) Inventor: Volker Knop, Ulmen (DE)

(73) Assignee: ZF Active Safety GmbH, Koblenz (DE)

(21) Appl. No.: 19/207,738

(22) Filed: May 14, 2025

(30) Foreign Application Priority Data
May 14, 2024 (DE) 102024113499.2

(51) Int. Cl. B60T 13/74; B60T 8/17; B60T 17/22; F16D 65/18; F16D 121/24; F16D 125/32; F16D 125/40; F16D 125/52; F16D 127/06

(52) U.S. Cl. CPC B60T 13/746; B60T 8/17; B60T 17/22; F16D 65/18; F16D 2121/24; F16D 2125/32; F16D 2125/40; F16D 2125/52; F16D 2127/06

(57) ABSTRACT

A brake actuator is disclosed for an electromechanical vehicle brake, comprising an electric motor for actuating the vehicle brake, a blocking assembly for selectively rotationally blocking an output shaft of the electric motor for the purposes of implementing a parking brake function. The blocking assembly comprises a blocking module, which is mounted so as to be movable linearly between an arresting position and a release position, and a drive for moving the blocking module. The brake actuator further includes an electronic detection device for detecting the arresting position and/or the release position of the blocking module. Also specified is a method for operating a brake actuator.

### CROSS-REFERENCE TO RELATED APPLICATIONS

This application claims priority to German Patent Application No. 102024113499.2, filed May 14, 2024, the disclosure of which is incorporated herein by reference in its entirety.

### TECHNICAL FIELD

The disclosure relates to a brake actuator, for example for an electromechanical vehicle brake, having an electric motor for actuating the vehicle brake, and having a blocking assembly for selectively rotationally blocking an output shaft of the electric motor for the purposes of implementing a parking brake function, and to a method for operating a brake actuator.

### BACKGROUND

Brake actuators are used in vehicle brakes to press a brake pad against a brake rotor. For this purpose, the brake actuator commonly has an electric motor that is coupled in terms of drive via a transmission unit and a spindle drive to an actuating carriage which is selectively movable between a retracted position and an extended position for the purposes of pressing the brake pad against the brake rotor. For example, an axial brake-application force for pressing the brake pad against the brake rotor is transmitted from the actuating carriage to the brake pad.

As well as functioning as a service brake, the electromechanical vehicle brake is also intended to function as a parking brake. Since the service brake function is self-releasing, a blocking lever is commonly provided for the purposes of implementing a parking brake function, which blocking lever arrests the mechanism of the vehicle brake such that the vehicle brake cannot be released.

What is needed is to provide a brake actuator that is configured to yet further enhance the functionality of the service brake.

### SUMMARY

Said object is achieved according to the disclosure by a brake actuator, for example for an electromechanical vehicle brake, having an electric motor for actuating the vehicle brake, and having a blocking assembly for selectively rotationally blocking an output shaft of the electric motor for the purposes of implementing a parking brake function. The blocking assembly comprises a blocking module, which is mounted so as to be movable linearly between an arresting position and a release position, and a drive for moving the blocking module. The brake actuator furthermore comprises an electronic detection device for detecting the arresting position and/or the release position of the blocking module.

By virtue of an arresting position and/or a release position of the blocking module being detected, the functional reliability of the brake actuator is increased. More specifically, when a vehicle is in a parked state, it can be identified whether the mechanism of a vehicle brake has actually been arrested such that the vehicle brake cannot disengage of its own accord.

For example, the blocking module is formed in two parts and comprises a slide and a blocking part, wherein the blocking part is mounted resiliently on the slide. The resilient mounting allows so-called “hot re-tensioning” of the brake actuator. More specifically, the resilient mounting means that, when the electric motor is actuated in a direction for intensifying a braking force, the blocking part can move out of the arresting position slightly whilst the blocking module is situated in the arresting position.

Hot re-tensioning is necessary if the clamping force of the vehicle brake in a parked situation decreases as a result of the vehicle brake cooling down after the parking operation.

In one exemplary arrangement, the blocking part has, at an end directed away from the slide, a blocking tooth which has a blocking geometry on one tooth flank and has a lifting-out geometry on an opposite tooth flank, said geometries being designed such that, if the electric motor rotates in a first direction for intensifying a braking force, the rotation of the electric motor causes the blocking part to be lifted out of the arresting position counter to a spring force, and a rotation of the electric motor in an opposite direction for eliminating the braking force is blocked. A ratchet function is thus realized, such that hot re-tensioning of the brake actuator is possible at any time without the need to release the arresting of the blocking assembly by the drive.

The tooth flank that has the blocking geometry is steeper than the tooth flank that has the lifting-out geometry. It is thus ensured that the blocking part cannot be lifted out of the arresting position when the electric motor rotates in a direction for eliminating the braking force.

For example, when the blocking module is in the arresting position, the blocking part engages with a drive pinion that is arranged directly on the output shaft of the electric motor. The drive pinion is acted on by a relatively low torque owing to the size of the pinion, such that the forces that act on the blocking module, for example, the forces that act on the blocking part, are correspondingly low. An inexpensive design of the blocking module is thus made possible. In other words, the blocking module can be designed to be less stable than would be required for higher torques.

Due to the detection device, the number of teeth of the drive pinion that are passed over during hot re-tensioning can be detected.

In one exemplary arrangement, the detection device is designed such that the position of the slide and the position of the blocking part can be detected separately. This allows energy-efficient operation of the blocking assembly, because the drive for moving the blocking module can be deactivated as soon as the slide has reached an end position, whilst the blocking part is still following on behind.

It is particularly advantageous if an arresting position of the slide and of the blocking part can be detected separately. If the slide is in the arresting position without the blocking part having reached said arresting position, this is an indication that the blocking tooth of the blocking part has come to lie directly on a tooth of the drive pinion. As a result of this, an angular position of the electric motor can be adjusted in order to eliminate the obstruction of the blocking part.

To limit a maximally extended position of the blocking part relative to the slide, an axial stop for the blocking part may be provided on the slide. The axial stop simultaneously serves as a driver geometry between the slide and the blocking part during a movement of the blocking module into the release position.

To implement the resilient mounting, in each case one centring projection is formed on the slide and on the blocking part, on which centring projections a compression spring is centred. The compression spring forces the blocking part against the axial stop of the slide.

In one exemplary arrangement, the drive for moving the blocking module comprises a helical gear mechanism. Such mechanisms are self-locking, such that the blocking module remains in the arresting position even after the drive has been deactivated. This also contributes to energy-efficient operation of the brake actuator.

For example, the helical gear mechanism comprises a worm gear and a helically toothed gear, wherein a spiral-shaped groove is formed in the helically toothed gear, and wherein a pin that is fixedly connected to the blocking module is guided in the spiral-shaped groove. The rotation of the helically toothed gear consequently causes the pin and thus also the blocking module to be moved linearly, such that a linear drive for the blocking module is easily implemented.

In one exemplary arrangement, the pin is fixedly connected to the slide, wherein the pin may be formed as a single piece with the slide or separately.

In one exemplary arrangement, the brake actuator comprises an electronics unit for controlling the electric motor, said electronics unit being accommodated in an electronics housing, wherein the detection device for detecting the arresting position and/or the release position of the blocking module is part of the electronics unit. This contributes to a compact design of the brake actuator.

For example, the electronics unit for controlling the electric motor is formed on a circuit board, and the detection device is arranged on the same circuit board.

The detection device may comprise at least one microswitch for detecting the arresting position and/or the release position of the blocking module. In one exemplary arrangement, the detection device comprises three microswitches, wherein one microswitch detects a release position of the slide, and in each case one further microswitch detects an arresting position of the slide and an arresting position of the blocking part. Through the use of microswitches, it is possible to determine the end positions of the blocking module or of the slide and of the blocking part, which end positions correspond to a release position and an arresting position respectively.

On the slide and/or on the blocking part, there may be provided a protrusion which activates the at least one microswitch when the blocking module is in an arresting position and/or a release position, wherein, the protrusion projects into the electronics unit. More specifically, the protrusion actuates the microswitch by abutting against said microswitch when in an end position. Since the at least one microswitch is activated by a protrusion formed integrally on the blocking part, the microswitch can be positioned flexibly relative to the blocking module. Depending on the length of the protrusion, the at least one microswitch may be arranged at a certain distance from the blocking module.

For example, the electric motor is coupled in terms of drive via a transmission unit and a spindle drive to an actuating carriage which is selectively movable between a retracted position and an extended position for the purposes of pressing a brake pad against a brake rotor. A rotation of the electric motor can thus be converted into a linear movement of the actuating carriage, giving rise to an axial brake-application force for pressing the brake pad against the brake rotor.

The brake actuator may comprise a frame part on which the transmission unit is mounted, wherein a linear guide for the blocking module is formed in the frame part. The linear guide defines the movement direction of the blocking module. The fact that the linear guide is formed on the frame part furthermore contributes to a compact design of the brake actuator.

The brake actuator may comprise a frame part on which the transmission unit is mounted, wherein a linear guide for the blocking module is formed in the frame part. The linear guide defines the movement direction of the blocking module. The fact that the linear guide is formed on the frame part furthermore contributes to a compact design of the brake actuator.

The helically toothed gear of the helical gear mechanism may also be mounted on the frame part, for example, on a side situated opposite the linear guide.

The electronics unit may also be fastened to the frame part, and covers the linear guide.

A method for operating a brake actuator according to the disclosure is also disclosed, the blocking module of which is formed in two parts and comprises a slide and a blocking part, wherein the blocking part is mounted resiliently on the slide. In a first method step, the blocking module is moved from the release position into the arresting position. As soon as the detection device detects that the slide of the blocking module is in the arresting position, the drive for moving the blocking module is deactivated. If the detection device detects that the blocking part of the blocking module is not in the arresting position after the slide has already reached the arresting position, an angular position of the electric motor for actuating the vehicle brake is varied until the blocking part has been moved into the arresting position.

It is thus ensured that the blocking part fully engages by way of the blocking tooth into a blocking geometry, for example, a blocking geometry in a drive pinion.

If the blocking tooth comes to lie exactly on a tooth tip of the drive pinion, the angular position of the electric motor is varied. As soon as the blocking part is in the arresting position, this is detected by the detection device, and the electric motor is deactivated.

### BRIEF DESCRIPTION OF THE DRAWINGS

Further advantages and features of the disclosure will emerge from the following description and from the appended drawings, in which:

FIG. 1 shows a vehicle brake having a brake actuator according to the disclosure,

FIG. 2 shows the vehicle brake from FIG. 1 in a sectional illustration,

FIG. 3 shows a part of the brake actuator from FIGS. 1 and 2 in an exploded illustration,

FIG. 4 shows a locking mechanism in an installation space environment of the brake actuator,

FIG. 5 shows the blocking mechanism from FIG. 4 in a detail view,

FIG. 6 shows a part of the drive of the blocking mechanism,

FIG. 7 shows the blocking mechanism in an exploded illustration,

FIG. 8 shows a blocking module of the blocking mechanism in an exploded illustration,

FIG. 9 shows the blocking module from FIG. 8,

FIG. 10 shows a detection device of the brake actuator,

FIG. 11 shows the blocking mechanism having the detection device in a release state,

FIG. 12 shows the blocking mechanism having the detection device in an arresting state, and

FIG. 13 shows the blocking mechanism having the detection device in a further state.

### DETAILED DESCRIPTION

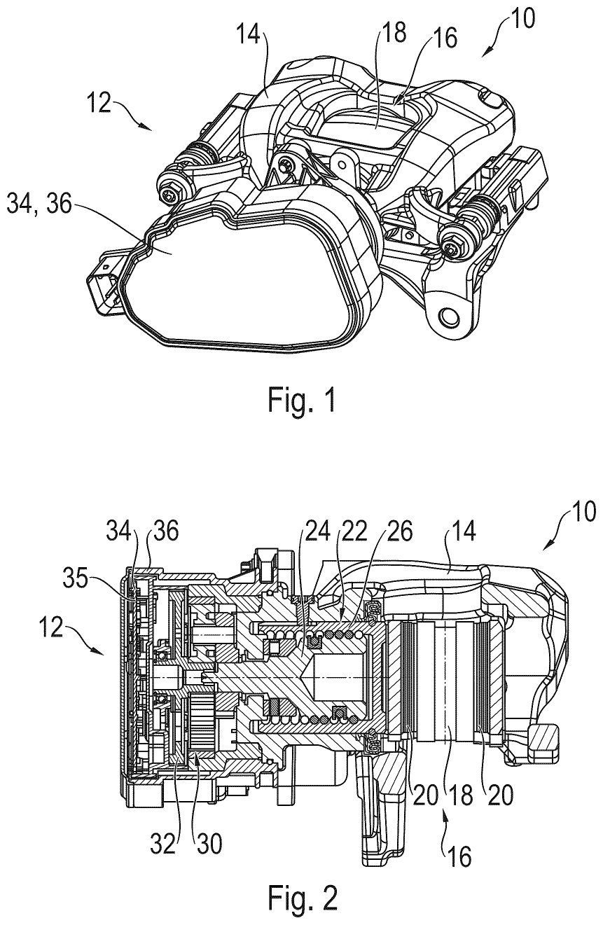

FIGS. 1 and 2 show a vehicle brake 10 having a brake actuator 12 in a perspective view and in a sectional illustration. The vehicle brake 10 is an electromechanically actuatable brake.

The brake actuator 12 comprises a brake caliper 14 in which an intermediate space 16 for a brake rotor 18 is formed.

A brake pad 20 (see FIG. 2) is arranged in the intermediate space 16 and can be pressed against the brake rotor 18.

The brake actuator 12 furthermore comprises a spindle drive 22, which in the exemplary arrangement is a ball screw drive, having a rotatably mounted spindle 24 which is driven by an electric motor and on which an actuating carriage 26 is mounted. The spindle 24 serves for axially moving the actuating carriage 26. The actuating carriage 26 forms the spindle nut of the spindle drive 22. Specifically, the actuating carriage 26 constitutes a brake piston.

The actuating carriage 26 is selectively movable, by axial displacement, between an extended position and a retracted position for the purposes of pressing the brake pad 20 against the brake rotor 18.

In the extended position, the actuating carriage 26 presses against the brake pad 20 and transmits an axial brake-application force to the brake pad 20.

The brake actuator 12 furthermore comprises an electric motor 28 (see FIG. 4) for actuating the vehicle brake.

The brake actuator furthermore comprises a transmission unit 30.

The electric motor 28 is coupled in terms of drive via the transmission unit 30 and the spindle drive 22 to the actuating carriage 26 in order to move the actuating carriage 26 between the retracted position and the extended position.

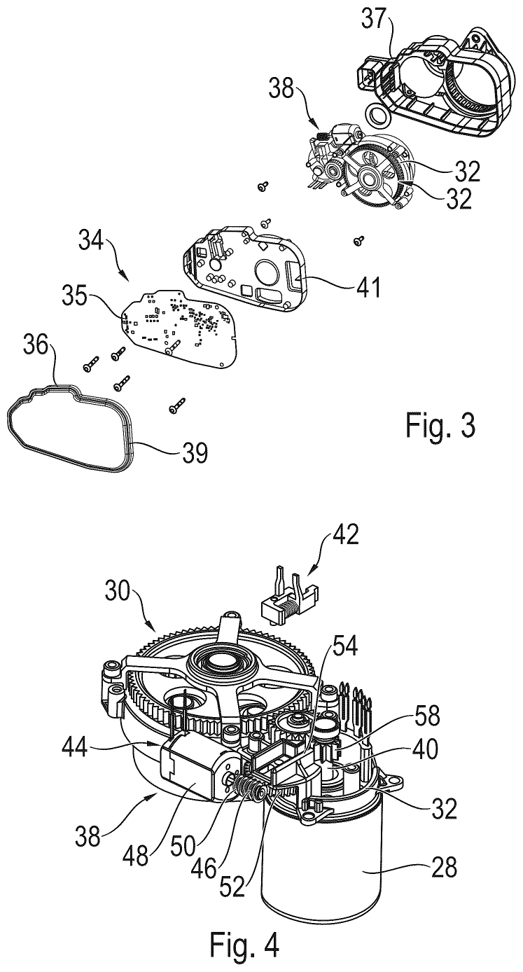

The transmission unit 30 is mounted on a frame part 32 of the brake actuator 12, as can be seen in FIG. 3.

The frame part 32 absorbs all reaction forces and reaction torques that arise when the vehicle brake 10 is actuated, and dissipates these into the brake caliper 14.

To control the electric motor 28, the brake actuator 12 comprises an electronics unit 34, which is accommodated in an electronics housing 36.

In the exemplary arrangement, the electronics unit 34 is a circuit board 35, as can be seen in FIG. 3. The electronic components required for controlling the electric motor 28 are arranged on the circuit board 35.

In the exemplary arrangement, the electronics housing 36 is fastened to the frame part 32.

The frame part 32 together with the transmission unit 30 is accommodated in a further housing 37, wherein the electronics housing 36, for example, one of two housing shells 39, 41 of the electronics housing 36, forms the cover of the housing 37.

The vehicle brake 10 is the service brake of a vehicle. That is to say, the vehicle brake 10 serves for braking the vehicle during normal driving operation.

For this reason, the vehicle brake 10 is of self-releasing design. This means that, during normal driving operation, as soon as the electric motor 28 is not active, the actuating carriage 26 can move and be released from the brake pad 20.

To additionally implement a parking brake function, the brake actuator 12 has a blocking assembly 38 for selectively rotationally blocking an output shaft 40 (see FIG. 4) of the electric motor 28.

The blocking assembly 38 is illustrated in FIGS. 4 to 9.

FIG. 4 shows the blocking assembly 38 in an installation space environment in the brake actuator 12.

The blocking assembly 38 comprises a blocking module 42, which is mounted so as to be movable linearly between an arresting position and a release position, and a drive 44 for moving the blocking module 42, said drive being formed in the exemplary arrangement as a helical gear mechanism 46 with an electric motor 48, for example, a miniature DC electric motor.

The electric motor 48 is electronically connected by press-in plug contacts to the electronics unit 34, for example to the conductor tracks of the circuit board 35.

The helical gear mechanism 46 comprises a worm gear 50 and a helically toothed gear 52.

The worm gear 50 is seated on a motor shaft of the electric motor 48.

The helically toothed gear 52 is mounted on the frame part 32.

Furthermore, a linear guide 54 is formed in the frame part 32, said linear guide, for example, taking the form of two parallel walls, between which the blocking module 42 is inserted.

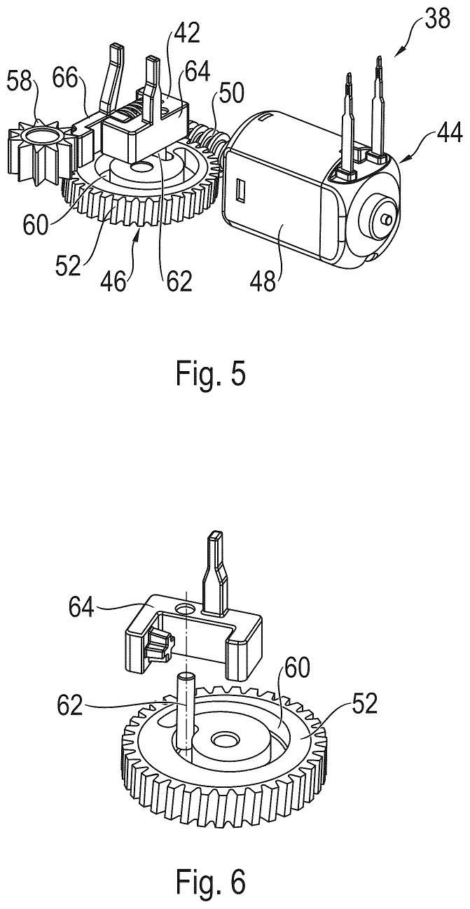

When in its arresting position, the blocking module 42 engages with a drive pinion 58 that is arranged directly on the output shaft 40 of the electric motor 28, as illustrated in FIG. 5.

A spiral-shaped groove 60 is formed in the end face of the helically toothed gear 52, as can be seen clearly in FIGS. 5 to 7.

A pin 62 that is fixedly connected to the blocking module 42 is guided in the groove 60.

When the helically toothed gear 52 rotates, the blocking module 42 is moved linearly owing to the spiral shape of the groove 60 and owing to the linear guide 54.

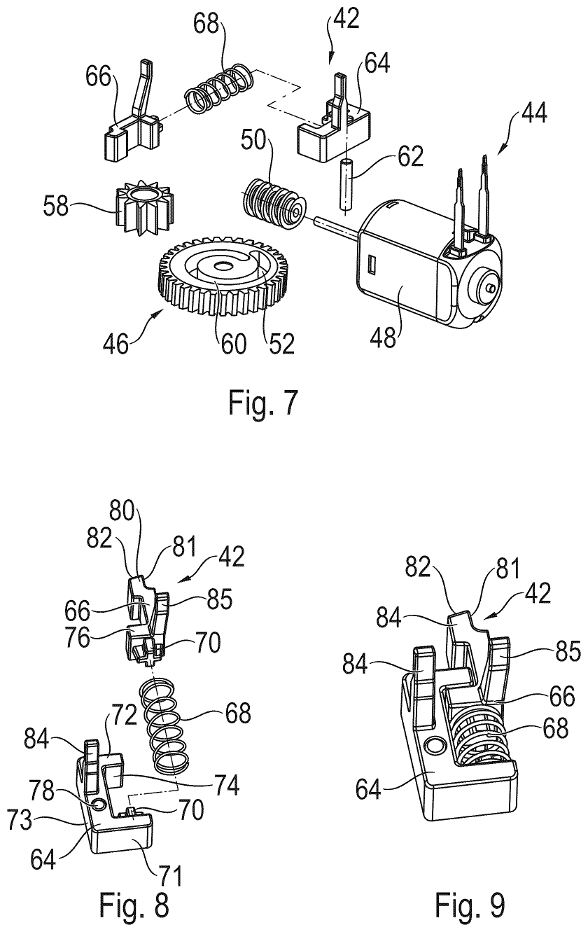

The blocking module 42 is formed in two parts, as can be seen clearly in FIGS. 7 to 9.

More specifically, the blocking module 42 comprises a slide 64 and a blocking part 66, wherein the blocking part 66 is mounted resiliently on the slide 64.

For this purpose, a compression spring 68 is mounted between the slide 64 and the blocking part 66, said compression spring being centred with its opposite ends on in each case one centring projection 70 (see FIG. 8), wherein one centring projection 70 is formed on the slide 64 and one centring projection 70 is formed on the blocking part 66.

The resilient mounting allows hot re-tensioning of the vehicle brake 10.

The slide 64 is C-shaped and has two legs 71, 72 and a connecting portion 73 that connects that legs 71, 72, as can be seen in FIG. 8.

The centring projection 70 is formed on a first leg 71 of the slide.

An axial stop 74 for the blocking part 66 is formed on a second leg 72 that is situated opposite the first leg 71.

The blocking part 66 has a base 76, which in one exemplary arrangement is cuboidal and which, when the blocking module 42 is in the assembled state, is arranged between the legs 71, 72 of the slide 64. An abutment surface for the axial stop 74 is provided on one end face of the base 76, and the centring projection 70 is arranged on the opposite end face.

The slide 64 also has a receptacle 78 for the pin 62. It is however also conceivable for the pin 62 to be manufactured as a single piece with the slide 64.

The blocking part 66 has a blocking tooth 80, for example, at an end that is directed away from the slide 64 or from the base 76.

The blocking tooth 80 has a blocking geometry 81 on one tooth flank and has a lifting-out geometry 82 on an opposite tooth flank, said geometries being of oblique form such that, if the electric motor 28 rotates in a first direction for intensifying a braking force, the rotation of the electric motor causes the blocking module to be lifted out of the arresting position counter to a spring force, and a rotation of the electric motor 28 in an opposite direction for eliminating the braking force is blocked if the blocking module 42 is in the arresting position.

Formed integrally both on the slide 64 and on the blocking part 66 is in each case one protrusion 84, 85, the function of which will be discussed below.

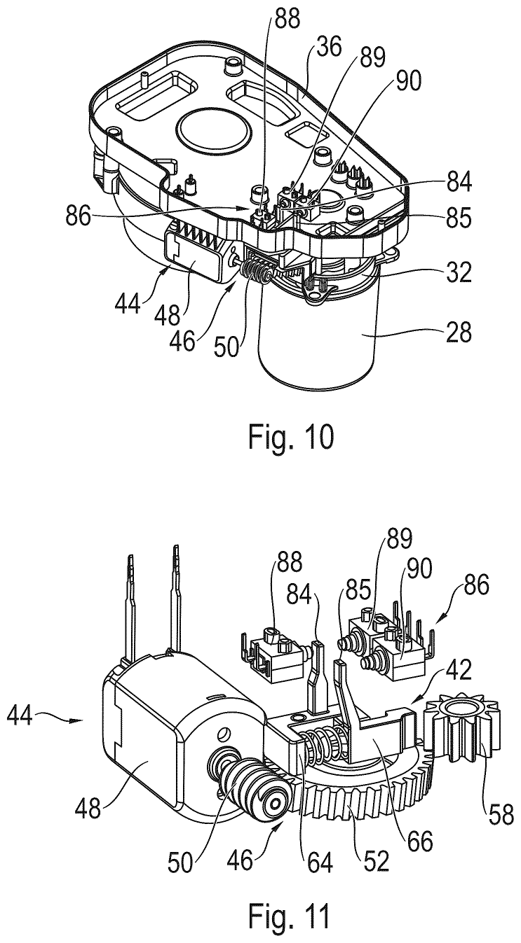

The protrusions 84, 85 project into the electronics unit 34, as can be seen in FIG. 10.

FIG. 10 also shows an electronic detection device 86 for detecting the arresting position and the release position of the blocking module 42.

In the exemplary arrangement illustrated, the detection device 86 for detecting the arresting position and the release position of the blocking module 42 is part of the electronics unit 34.

The detection device 86 comprises three microswitches 88, 89, 90, though it is alternatively also conceivable for only two or four microswitches to be provided.

The microswitches 88, 89, 90 are arranged on the circuit board 35 and are in contact with conductor tracks of the circuit board 35.

A first microswitch 88 detects a release position of the slide 64, and in each case one further microswitch 89, 90 detects an arresting position of the slide 64 and an arresting position of the blocking part 66.

The protrusions 84, 85, which in their end positions each actuate an associated microswitch 88, 89, 90, serve here as a triggering mechanism.

The functioning of the blocking assembly 38, and a method for operating a brake actuator 12, will be described with reference to FIGS. 11 to 13.

FIG. 11 shows the blocking assembly 38 in a state in which the blocking module 42 is in a release position. In this state, the protrusion 84 of the slide 64 actuates the first microswitch 88, such that the detection device 86 identifies that the blocking module 42 is in the release position. In this state, the vehicle brake 10 functions as a normal service brake.

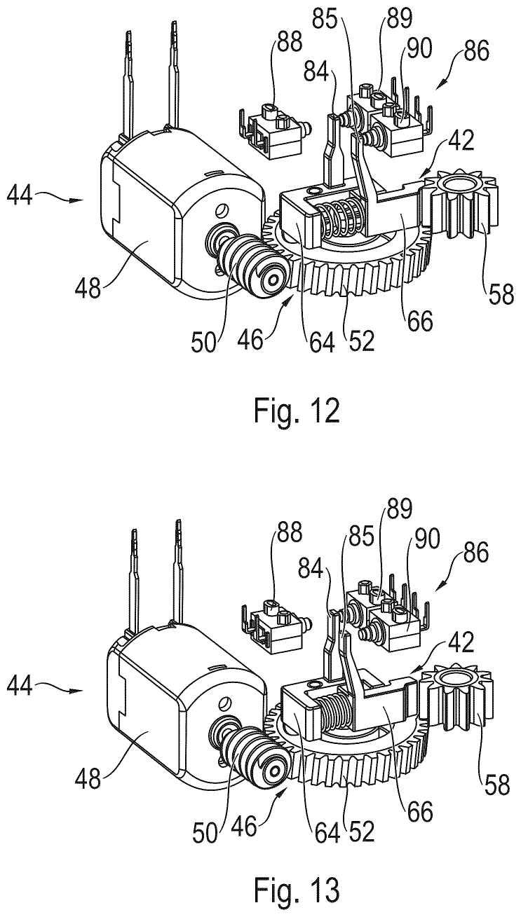

FIG. 12 shows the blocking assembly 38 in a state in which the blocking module 42 has been moved by the drive 44 into an arresting position.

In this state, the protrusions 84, 85 actuate the microswitches 89, 90, such that the detection device 86 identifies that the blocking module 42, for example, the slide 64 and the blocking part 66, is/are in the arresting position.

Once the slide 64 has reached the arresting position, the drive 44 or the electric motor 48 is deactivated. Owing to the self-locking design of the helical gear mechanism 46, the slide 64 remains in the arresting position even after the drive 44 has been deactivated.

In this state, the blocking tooth 80 engages with the drive pinion 58 that is mounted on the output shaft 40 of the electric motor 28. The vehicle brake 10 thus functions as a parking brake.

In this state, a rotation of the electric motor 28 in a direction for eliminating the braking force is blocked.

In this state, the blocking module 42 is supported on the linear guide 54 and dissipates the backward torque, which is transmitted from the drive pinion 58 to the blocking module 42, into the brake caliper 14 via the frame part 32.

A rotation of the electric motor 28 in a direction for intensifying the braking force is however possible for the purposes of hot re-tensioning.

Here, the rotation of the electric motor 28 causes the blocking part 66 to be lifted out of the arresting position counter to the spring force of the compression spring 68, which is made possible by the lifting-out geometry 82 on the corresponding tooth flank of the blocking tooth 80.

Here, the blocking part 66, for example, the blocking tooth 80, follows the contour of the drive pinion 58.

During hot re-tensioning, the detection device 86 can, on the basis of how often the microswitch 90 has been actuated, determine how many teeth of the drive pinion 58 the blocking part 66 has passed over. It can thus be determined whether the actuating carriage 26 has performed a sufficient stroke movement.

Owing to the self-locking design of the helical gear mechanism 46, the blocking module 42 remains in the arresting position until the drive 44 is actuated again.

If the blocking module 42 is moved out of the arresting position into the release position, the detection device 86 identifies that the slide 64 is in the release position when the microswitch 88 is actuated, and deactivates the electric motor 48 again.

Owing to the coupling to the slide 64 by the axial stop 74, the blocking part 66 is also situated in the released position when the slide 64 is in the release position. The release position of the blocking part 66 therefore does not need to be detected separately, eliminating the need for a microswitch.

FIG. 13 also illustrates a state in which the blocking module 42 has been moved from the release position into the arresting position, but in which the blocking part 66 has not fully reached the arresting position.

As soon as the detection device 86 detects that the slide 64 of the blocking module 42 is in the arresting position, as illustrated in FIG. 13, the drive 44 for moving the blocking module 42 is deactivated.

If the detection device 86 detects that the blocking part 66 of the blocking module 42 is not in the arresting position after the slide 64 has already reached the arresting position, this is an indication that, during the movement into the arresting position, the blocking tooth 80 of the blocking part 66 has come to lie exactly on a tooth tip of the drive pinion 58 and has thus been obstructed.

An angular position of the electric motor 28 for actuating the vehicle brake 10 is thereupon varied until the blocking part 66 has been moved into the arresting position, such that the state illustrated in FIG. 12 is attained.

Here, the blocking part 66 is moved by the energy stored in the compression spring 68.

The angular position of the electric motor 28 is varied for example through a defined angle.

It is alternatively also conceivable that a motor controller stored in the electronics unit 34 adjusts the angular position of the electric motor 28 from the outset such that the blocking part 66 comes to lie in a tooth space of the drive pinion 58.

1. A Brake actuator for an electromechanical vehicle brake, comprising,
an electric motor for actuating the vehicle brake,
a blocking assembly for selectively rotationally blocking an output shaft of the electric motor for implementing a parking brake function,
wherein the blocking assembly comprises a blocking module, which is mounted so as to be movable linearly between an arresting position and a release position, and a drive for moving the blocking module, and
an electronic detection device for detecting the arresting position and/or the release position of the blocking module.

2. The brake actuator according to claim 1, wherein the blocking module is formed in two parts and comprises a slide and a blocking part, wherein the blocking part is mounted resiliently on the slide.

3. The brake actuator according to claim 2, wherein that the blocking part has, at an end directed away from the slide, a blocking tooth which has a blocking geometry on one tooth flank and has a lifting-out geometry on an opposite tooth flank, said geometries being designed such that, if the electric motor rotates in a first direction for intensifying a braking force, the rotation of the electric motor causing the blocking part to be lifted out of the arresting position counter to a spring force, and a rotation of the electric motor in an opposite direction for eliminating the braking force is blocked.

4. The brake actuator according to claim 2, wherein, when the blocking module is in the arresting position, the blocking part engages with a drive pinion that is arranged directly on the output shaft of the electric motor.

5. The brake actuator according to claim 2, wherein the detection device is designed such that the position of the slide and the position of the blocking part can be detected separately.

6. The brake actuator according to claim 2, wherein an axial stop for the blocking part is provided on the slide.

7. The brake actuator according to claim 1, wherein that the drive for moving the blocking module comprises a helical gear mechanism.

8. The brake actuator according to claim 7, wherein the helical gear mechanism comprises a worm gear and a helically toothed gear, wherein a spiral-shaped groove is formed in the helically toothed gear, and wherein a pin that is fixedly connected to the blocking module is guided in the spiral-shaped groove.

9. Brake actuator according to claim 1, wherein the brake actuator comprises an electronics unit for controlling the electric motor, said electronics unit being accommodated in an electronics housing, wherein the detection device for detecting the arresting position and/or the release position of the blocking module is part of the electronics unit.

10. The brake actuator according to claim 1, wherein the detection device for detecting the arresting position and/or the release position of the blocking module comprises at least one microswitch, wherein one microswitch detects a release position of the slide.

11. The brake actuator according to claim 10, wherein, on the slide and/or on the blocking part, there is provided a protrusion which activates the at least one microswitch when the blocking module is in an arresting position and/or a release position.

12. The brake actuator according claim 1, wherein the electric motor is coupled in terms of drive via a transmission unit and a spindle drive to an actuating carriage which is selectively movable between a retracted position and an extended position for the purposes of pressing a brake pad against a brake rotor.

13. The brake actuator according to claim 12, wherein the brake actuator comprises a frame part on which the transmission unit is mounted, wherein a linear guide for the blocking module is formed in the frame part.

14. A method for operating a brake actuator according to claim 1, wherein the blocking module of which is formed in two parts and comprises a slide and a blocking part, wherein the blocking part is mounted resiliently on the slide, the method comprising the following steps:
moving the blocking module from the release position into the arresting position;
after detection by the detection device that the slide of the blocking module is in the arresting position, deactivating the drive for moving the blocking module;
wherein if the detection device detects that the blocking part of the blocking module is not in the arresting position after the slide has already reached the arresting position, varying an angular position of the electric motor for actuating the vehicle brake until the blocking part has been moved into the arresting position.

15. The brake actuator according to claim 1, wherein the detection device for detecting the arresting position and/or the release position of the blocking module comprises a plurality of microswitches, wherein at least one microswitch detects a release position of the slide, and in each case one further microswitch detects an arresting position of the slide and an arresting position of the blocking part.

16. The brake actuator according to claim 4, wherein the detection device is designed such that the position of the slide and the position of the blocking part can be detected separately.

17. The brake actuator according to claim 16, wherein an axial stop for the blocking part is provided on the slide.

18. The brake actuator according to claim 4, wherein the drive for moving the blocking module comprises a helical gear mechanism.

19. The brake actuator according to claim 4, wherein the brake actuator comprises an electronics unit for controlling the electric motor, said electronics unit being accommodated in an electronics housing, wherein the detection device for detecting the arresting position and/or the release position of the blocking module is part of the electronics unit.

20. The brake actuator according to claim 4, wherein the detection device for detecting the arresting position and/or the release position of the blocking module comprises a plurality of microswitches, wherein at least one microswitch detects a release position of the slide, and in each case one further microswitch detects an arresting position of the slide and an arresting position of the blocking part.
